(19) United States
(12) Patent Application Publication
(10) Pub. No.: US 2003/0232911 A1
(43) Pub. Date: Dec. 18, 2003

(54) Feedstock for injection molding

(76) Inventors: Bing-Joe Hwang, Taipei (TW); Shun-Tian Lin, Hsi Chih City (TW); Loka Subramanyam Sarma, Taipei (TW); Ming-Yao Cheng, Taipei (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/170,464

(22) Filed: Jun. 14, 2002

(51) Int. Cl. C08K 5/09

(52) U.S. Cl. 524/284; 524/503; 524/523

(57) ABSTRACT

A ceramic injection molding composition consisting of a three component binder system with a ceramic powder in which the binder system has good wettability towards the ceramic powder was disclosed. The binder system includes a first component soluble in water, a second component which is a water emulsified acrylic resin and a third component as a lubricant. A homogeneous powder binder blend can be achieved during low temperature mixing of the powder. As the binder system has strong affinity towards the ceramic powder and easily mixed with ceramic powder it eliminates the use of a high temperature mixing which involves difficult instruments. The binder system was successfully applied to a wide range of ceramic powders. The composition of the binder system depends on the powder and its density. Addition of water to powder binder mixture enhances the dispersion of powder into binder. Use of water to remove water soluble component from the molded compact is an added advantage of this binder system as it eliminates the use of organic solvents generally used in solvent debinding step which are harmful and environmentally unsafe. The binder system disclosed here permits the molded article incapable of sustaining defects such as cracks, blisters, expansion and deformation. The binder system is environmentally safe, fully degradable and non hazardous.

### BACKGROUND OF THE INVENTION

The main objective of this invention relates to a three component binder system for use in the ceramic powder injection molding.

Ceramic injection molding is a low cost way to produce complex and precision shaped parts from a variety of materials. The method involves the mixing of a binder components with a ceramic aid to prepare a compound for injection molding. Later, the compound can be molded into desired shapes with an injection molding machine.

The binder system plays an important role in ceramic injection molding processes. The powder and binder characteristics affect all subsequent processing decisions in powder injection molding. Control of the key constituent in the feedstock, the powder is fundamental to powder injection molding. Therfore, a precise balance is needed between powder attributes, binder composition, and the ratio of powder to binder. To get void-free, stress free and uniformly dense molded shape, it is desirable that the binder should have the following properties.

(a) good flow characteristics

(b) favourable interactions with ceramic aid

(c) good debinding characteristics

(d) low cost and

(e) be environmentally safe and eco friendly

The success of ceramic injection molding process mainly depends on the extent of dispersion of a ceramic powder into binder matrices. To achieve better dispersion so far inventors are using hot mixing methods.

The frequently encounter disadvantages of hot mixing methods are

(a) forms highly viscous materials

(b) abrasion against machine walls

(c) involves expensive equipment

(d) degradation of binder components at high temperatures

The unique feature of the present invention is that the proposed binder system have good affinity towards ceramic powder and the powder is well dispersed into binder system with a low temperature mixing method. A wet ball milling method is used to mix the powder and binder components. A homogeneous powder binder blends can be achieved in this mixing. The method has an added advantage that the balls used for mixing is made with the same ceramic powder. In this process contamination to feedstock will be reduced. Another feature of the present invention relates to use of water as a mixing medium. It eliminates the use of harmful, enivironmentally unsafe organic solvents frequently used as mixing medias in wet ball milling methods.

The most important part of a ceramic injection molding process for the production of defect free sintered member resides in the step of debinding. Several different binder removal methods are used depending on the chemical and physical properties of the binder formulation used. The debinding method which is currently in use is know in two kinds; the thermal debinding involves heating an injection molded mass to melt-flow, thermally decompose and gasify an organic binder contained therein and the solvent debinding, where the binder is dissolved using a chemical or water. However, the use of organic solvents are environmentally unsafe and hazardous. Hence, much of the current inventions related to water soluble binder systems.

Yang et. al., in U.S. Pat. No. 6,008,281 disclosed the invention of a water soluble binder system consisting of poly propylene, poly vinyl alcohol and a plasticizer. PVA is completely safe and when dissolved in water it is fully degradable, environmentally harmless and non hazardous. Though this patent discloses a good water soluble binder system the mixing of binder componets with powder involves hot mixing methods, which involves using high temperatures and costly equipments. Another binder system disclosed in U.S. Pat. No. 5,332,537 which have the components poly ethylene glycol, poly butyryl resin also involves the mixing with ceramic powder by Sigma blade mixer at min. temp of 200° C. Seyama et al., also disclosed a water soluble binder system for ceramic powders in their U.S. Pat. No. 5,741,833. They prepared a raw material for injection molding by kneading the binder components with ceramic powder at high temperatures. The binder systems which disclosed in U.S. Pat. Nos. 5,744,532, 5,008,054, 5,409,650, 4,197,118, 4,404,166 and 4,113,480 with a view to develop high formability, highly desirable degreasing property and desirable viscosity involves use of organic solvents in debinding methods.

The prior art as described above employed hot mixing methods, using harmful solvents as mixing medias in case of wet mixing methods. Describing the nature of the binder systems in general and in particular the nature of the invented binder system the summarisied attributes of the present binder system are:

(a) It has good affinity for ceramic powders and it disperse well into powder material during mixing

(b) It has good viscosity. So, the feedstock exhibits desirable fluidity during the step of injection molding

(c) Desirable solubility to water and it eliminates the use of organic solvent to remove binder from molded compact

(d) With the proposed binder system the sintered body has no defects such as deformation, blisters and cracks

(e) All the components of the binder system are completely safe, harmless and fully degradable

(f) The debinding process is simple, safe and inexpensive

### SUMMARY OF THE INVENTION

In general, the present invention provides a three component binder system for powder injection molding of ceramics and a mixing method of the binder system with ceramic powder at low temperatures. The binder components includes a first component which is soluble in water, a second component which is insoluble in water, a third component which is a carboxylic acid or its salt and a processing aid. The binder components are mixed with suitable ceramic powders by using low temperature wet ball milling methods.

The feedstock, which is a mixture of ceramic powder and a binder is molded to form a compact. The compact is exposed to water to remove water soluble first component of the binder system. Thereafter, thermal treatment is given to the compact in order to remove the water insoluble component. The powder in the compact is finally sintered to form an article.

### DETAILED DESCRIPTION OF THE INVENTION

The details of the present invention will be explained in detail herein below.

In accordance with the present invention, there are used as a binder a first component which is soluble in water and a second component which is a water emulsified acrylic resin which has a melting point higher than that of the first component and a third component choosen one from the group of carboxylic acid or their salts as a lubricant. The ceramic powder particles are first coated with the water emulsified acrylic resin and then the first component, third component and water as a processing aid were added and stirred. The mixture was then ball milled by using the balls prepared with the same powder used in the formulation. The resultant mixture is dried to give a feedstock for injection molding. The molded specimen is immersed in water to remove the water soluble first component. Later, the specimens were thermally debinded to remove the remaining components and then finally sintered.

Because the main objective of the present invention is to develop water soluble binder system for ceramic powders, so the present invention is illustrated below with reference to examples comprising of powder-binder formulations.

### EXAMPLE-I

A polyethylene glycol was used as the water soluble first component and a water emulsified acrylic resin is used as water insoluble second component. A 3 mol % yittria stabilized zirconia as the ceramic powder. The total amount of binder was kept 50% by volume.

The ceramic powder first mixed with the second component a water emulsified acrylic resin and stirred with a speed of 200 rpm and first component polyethylene glycol was added to the mixture followed by a third component a carboxylic acid and water as a processing medium. The total mixture was stirred for an hour with a rotating speed of 600 rpm. One third volume of the balls to that of total volume of the mixture were added and ball milled for two hours. The resultant mixture was dried, pelletized in order to produce the feedstock for injection molding.

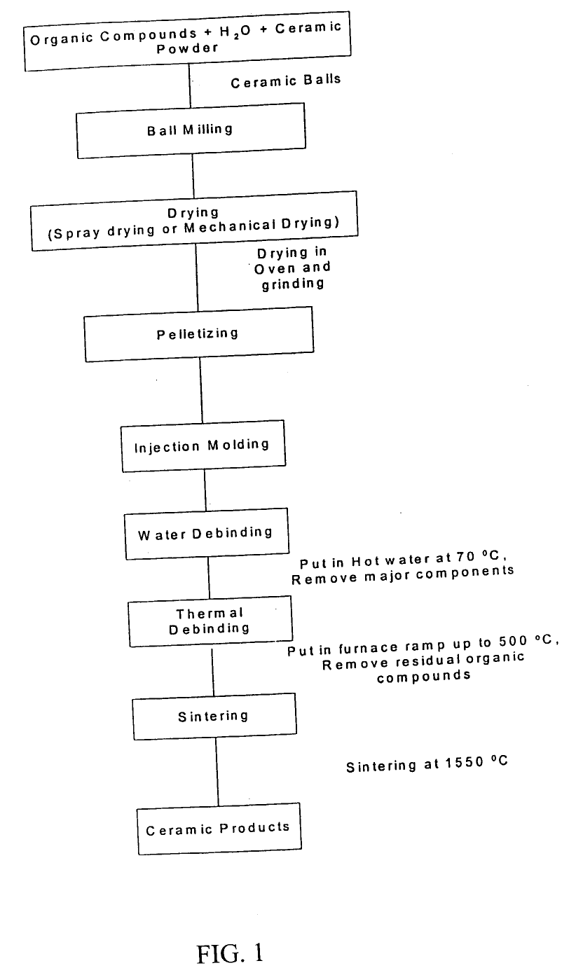

Four kinds of formulations by using different proportions of ceramic powder and binder constituents were prepared in order to check their performance for successful injection molding. The simple molding process is shown in the FIG. 1 and the compositions of the formulations were shown in Table-1.

TABLE 1

| | Formula | Formula | Formula | Formula |
|---|---|---|---|---|
| | 1 | 2 | 3 | 4 |
| Components | (wt %) | (wt %) | (wt %) | (wt %) |
| 3 mol % YSZ | 80.33 | 79.33 | 81.33 | 82.52 |
| PEG | 7.87 | 10.33 | 11.20 | 12.24 |
| Water emulsified | | | | |
| Acrylic resin | 8.65 | 6.84 | 4.49 | 2.49 |
| Carboxylic acid/salt | 0.42 | 1.00 | 0.52 | 0.50 |
| Water | 2.73 | 2.50 | 2.46 | 2.25 |

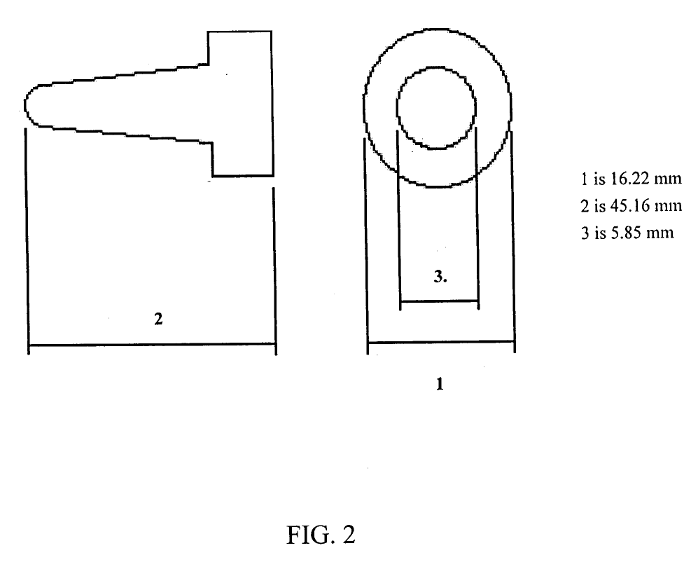

The above mentioned feedstocks were injection molded at 120° C. with injection pressure of 40 kg into tubular shape test pieces each having a dimension of 16.22×45.16×5.85 mm. The simple diagram of the molded specimen is shown in the FIG. 2. The molded parts were immersed in water at room temperature and at 70° C. each for 1 to 8 hrs. The samples were then dried after taking out of the water. The relationship between the percentage removal of water soluble component and the water immersion time was determined. The results obtained are shown in Table 2. As per the results shown in Table 2 almost 100% water soluble component was removed in 8 hours at 70° C.

Later, the dried molded parts were introduced into a nitrogen atmosphere furnace and the temperature raised initially from room temperature to 300° C. at a heating rate of 120° C./hr then to 500° C. at a heating rate of 180° C./hour and retained the molded part at this temperature for 1 hour. The conditions of the debinded products were observed and the results obtained are also shown in Table 2.

TABLE 2

| | | | | Heating | | |
|---|---|---|---|---|---|---|
| | Temp. of | Immersion | Percentage of | Rate(° C./hr) | | |
| Sample | Water | Time | PEG removal | 100 | 120 | 180 |
| Formula I | 25 | 2 | 35 | B | B | C |
| Formula I | 25 | 4 | 48 | B | B | C |
| Formula I | 25 | 8 | 60 | A | A | B |
| Formula I | 70 | 2 | 54 | A | B | B |
| Formula I | 70 | 4 | 78 | A | A | B |
| Formula I | 70 | 8 | 100 | A | A | A |

A: Sample without cracks and blisters
B: Sample with blisters
C: Sample with cracks

The thermally debound parts were then sintered at 1550° C. with a heating rate of 300° C./hr and holded the specimens at 1550° C. for 90 minutes.

We successfully injection molded, debinded the other 3 formulas of YSZ feedstock and sintered. All the sintered specimens had nearly 99% sintered density.

As the particle in the molded body of the present invention is fine the sintering properties of injection molded body and the like of sintered body are so excellent.

### EXAMPLE-II

In the second example of the present invention 8 mol % yttria stabilized zirconia is used as a ceramic powder. The binder components, mixing method and injection molding conditions were same which were descrbied in Example-I. The compositions of the formulations were shown in the table-3.

TABLE 3

| | Formula | Formula | Formula | Formula |
|---|---|---|---|---|
| | 1 | 2 | 3 | 4 |
| Components | (wt %) | (wt %) | (wt %) | (wt %) |
| 8 mol % YSZ | 82.40 | 81.16 | 82.68 | 83.26 |
| PEG | 5.20 | 7.73 | 8.13 | 9.44 |
| Water emulsified | | | | |
| Acrylic resin | 9.96 | 8.15 | 6.85 | 4.97 |
| Carboxylic acid/salt | 0.65 | 0.76 | 0.62 | 0.71 |
| Water | 1.79 | 2.20 | 1.72 | 1.60 |

The above feedstocks were injection molded by applying the conditions mentioned in example I and the molded compacts were immersed in water for 8 hours at 70° C. Then the thermal debinding was performed by applying the temperature profile specified in example 1. Sintered all the specimens at 1550° C. with a heating rate of 300° C./hour and holded the specimens at this temperature for 90 minutes.

The relative densities of the sintered specimens were calculated by using the following formula:

Relative Density=Found Density/Calculated density

From the results shown in Table 4 it has been demonstrated that the sintered members from the powder-binder compositions of the present invention possessed very high degree of relative density.

TABLE 4

Relative Density

| | |
|---|---|
| Formula 1 | 97.4 |
| Sintered body | |
| Formula 2 | 98.6 |
| Sintered body | |
| Formula 3 | 98.4 |
| Sintered body | |
| Formula 4 | 98.4 |
| Sintered body | |

### EXAMPLE-III

In the third example of the present invention alumina powder is used as a ceramic aid. The binder componets, mixing, and injection molding procedure same which were described in Example-I. The compositions of four kinds of powder-binder systems were shown in Table-5

TABLE 5

| | Formula | Formula | Formula | Formula |
|---|---|---|---|---|
| | 1 | 2 | 3 | 4 |
| Components | (wt %) | (wt %) | (wt %) | (wt %) |
| Al₂O₃ | 77.64 | 76.26 | 77.26 | 76.64 |
| PEG | 8.94 | 11.87 | 13.64 | 16.35 |
| Water emulsified | | | | |
| Acrylic resin | 10.56 | 8.39 | 5.89 | 3.99 |
| Carboxylic | 0.56 | 1.28 | 0.64 | 0.54 |
| acid/salt | | | | |
| Water | 2.30 | 2.20 | 2.57 | 2.48 |

The above moldable feedstocks were injection molded in the same condition as in Example 1 to obtain molded parts of the same shape as those obtained in example 1. Later, the molded parts were immersed in water at 70° C. for 8 hours. Dried the parts for one hour under vaccum after taking out of the water. Almost 100% water soluble component was removed. After that, the temperature of the dried molded parts was increased at a heating rate of 120° C./hour from room temperature to 300° C. and then to 500° C. at a heating rate of 180° C. and holded the specimen at this temperature for 1 hour. Observed the conditions of the debound parts and concluded that no cracks, no blisters and no deformation in the sample from which 100% PEG was removed. The results are shown in Table 6.

TABLE 6

| Immersion | % PEG | Amount of | Particulars of |
|---|---|---|---|
| Time | removed | deformation | defects |
| 2 | 35 | Large | Swelling |
| 4 | 50 | Medium | Blisters & cracks |
| 6 | 75 | None | Blisters |
| 8 | 100 | None | None |

The molded part was sintered in a heating furnace at 1500° C. at a heating rate of 300° C./hour and retained the compact at this temperature for 90 minutes and the sintered density was determined to be 3.98 g/cm³.

The present invention focuses only on the formulation of a binder system and a mixing method of said binder system with ceramic powder. This invention eliminates the use of environmentally unsafe and harmful solvents which are frequently used in solvent debinding methods. The present invention completely uses harmless debinding agents. With these agents, the debinding process becomes simple, inexpensive and non-hazardous. It has been demonstrated that the molded pieces using the powder injection molding binder and the powder injection molding composition according to the present invention did not sustain such damage as a crack or an expansion at the debinding step. Another added advantage of the present invention is that it avoids the use of sophisticated equipments and complicated procedures which usually employed in hot mixing methods in order to prepare a homogeneous powder-binder blends. Instead, the present invention employs a low temperature wet ball milling method which eliminates the use of expensive equipment and complicated procedures. Both the mixing and debinding methods are completely safe, harmless, eco-friendly, economical and convenient.

We claim:

1. A feedstock for injection molding consisting of
Powder particles selected at least one from the group of ceramic powder particles; and
A binder comprising of
A first component which is a water soluble resin, and
A second component which is a water emulsified acrylic resin, and
A third component which is a surfactant

2. A feedstock as set forth in claim 1, wherein said first component is a water soluble resin selected from the group at least one of polyethylene glycols, poly vinyl alcohols, poly vinyl acetates and methyl cellulose

3. A feedstock as set forth in claim 1, wherein said second water insoluble component is a water emulsified acrylic resin selected from the group consisting at least one of poly methyl methacrylate, poly ethyl methacrylate or poly butyl methacrylate

4. A feedstock as set forth in claim 1, wherein said surfactant is a carboxylic acid or its salt

5. A feedstock as set forth in claim 1, wherein the binder system further includes water as a processing media.
